(19) United States
(12) Patent Application Publication
(10) Pub. No.: US 2025/0386926 A1
(43) Pub. Date: Dec. 25, 2025

(54) SURFACE CONDITIONING ARTICLE

(71) Applicant: 3M INNOVATIVE PROPERTIES COMPANY, St. Paul, MN (US)

(72) Inventors: Jacob S. Beveridge, Stillwater, MN (US); Paul N. Daveloose, Maplewood, MN (US); Thomas J. Nelson, Woodbury, MN (US); Robinette S. Alkhas, Winnetka, CA (US); Jeremy K. Dworshak, North St. Paul, MN (US); Brook F. Duerr, Lake Elmo, MN (US)

(21) Appl. No.: 18/877,762

(22) PCT Filed: Jun. 29, 2023
(86) PCT No.: PCT/IB2023/056789

§ 371 Date: Dec. 20, 2024

Related U.S. Application Data
(60) Provisional application No. 63/367,517, filed on Jul. 1, 2022.

(51) Int. Cl. A46D 1/00; A46B 15/00; B29C 45/00

(52) U.S. Cl. CPC A46D 1/0207; A46B 15/001; B29C 45/0013; A46B 2200/3093

(57) ABSTRACT

A surface conditioning article is presented that includes a hub portion with a first material. The first material is free of abrasive particles. The article also includes a plurality of elongate abrasive elements, each extending along an element axis, and each of the primary elongate abrasive elements includes a second material.

### BACKGROUND

Surface conditioning discs and brushes are generally known for use in various cleaning, finishing, and deburring applications. Some surface conditioning articles include abrasive particles.

### SUMMARY OF THE INVENTION

Brushes have been used to polish, clean, and abrade a wide variety of substrates. These brush products typically have a plurality of bristles that contact the substrate. Abrasive particles can be added to bristles to increase their abrasiveness. However, abrasive particles are not required for all surface conditioning applications.

Systems and methods herein form bristle products in a two-step operation, allowing for improved control over properties of a hub portion from a bristle portion of a radial bristle brush.

A surface conditioning article is presented that includes a hub portion with a first material. The first material is free of abrasive particles. The article also includes a plurality of elongate abrasive elements, each extending along an element axis, and each of the primary elongate abrasive elements includes a second material.

A method of forming an abrasive article is presented that includes causing a first material to fill a first mold, the first material forms a hub in the first mold. The method also includes causing a second material to fill a second mold. The second material forms a plurality of elongate abrasive elements extending from the hub. The method also includes allowing the mixture to set such that the elongate abrasive elements are coupled to the hub such that the second material is coupled to the first material. The first material is free of abrasive particles and the second material includes abrasive particles.

The above summary is not intended to describe each embodiment or every implementation of the invention described herein. Rather, a more complete understanding of the invention will become apparent and appreciated by reference to the following description and claims in view of the accompanying figures of the drawing.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIGS. 1-3 illustrate surface conditioning articles with elongate components in accordance with embodiments herein.

FIGS. 4A-5B illustrate steps in the formation process of a surface conditioning article in accordance with embodiments herein.

FIG. 6 illustrates a method of forming a surface conditioning article in accordance with embodiments herein.

FIGS. 7A-7B illustrate surface conditioning articles with elongate components in accordance with embodiments herein.

FIG. 8 illustrates lamination patterns that may be used in accordance with embodiments herein.

FIG. 9A-9B illustrates a surface conditioning article in operation in accordance with embodiments herein.

### DETAILED DESCRIPTION OF THE FIGURES

The words “preferred” and “preferably” refer to embodiments described herein that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the terms “comprises” and variations thereof do not have a limiting meaning where these terms appear in the accompanying description. Moreover, “a,” “an,” “the,” “at least one,” and “one or more” are used interchangeably herein.

Relative terms such as left, right, forward, rearward, top, bottom, side, upper, lower, horizontal, vertical, and the like may be used herein and, if so, are from the perspective observed in the particular figure. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Described herein are “surface conditioning articles” that may include articles used for cleaning, removal of debris, abrading of surfaces (e.g. polishing, texturing, refining, deburring, sanding), or other suitable operations. Some surface conditioning articles described herein include abrasive particles in one or more components. However, it is expressly contemplated that many surface conditioning articles in embodiments herein can be formed without abrasive particles.

Surface conditioning articles 10 and assemblies according to the present disclosure may take the form of bristle brushes (rotary or otherwise) or discs, or components of brushes or discs, as described herein.

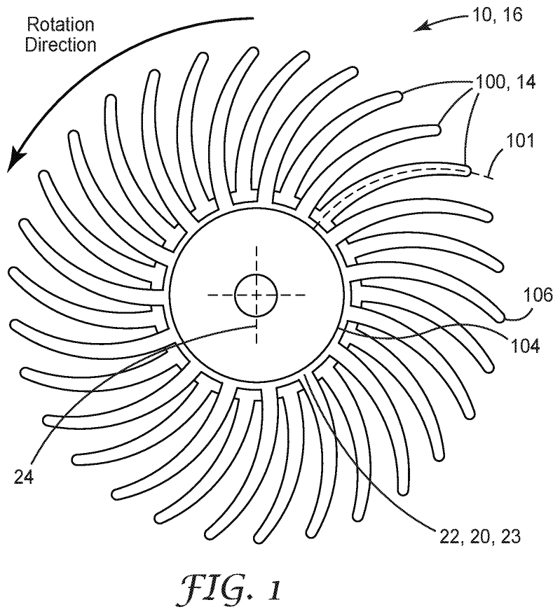

Referring to FIGS. 1 and 2, a surface conditioning article 10 may include a hub 104. A plurality of primary elongate elements 100 (e.g., bristles 14) may project outwardly from hub 104, beginning at element roots 22 (i.e., the end most proximal to the hub 22) and ending at element ends 106 (i.e., the end most distal from the hub 104). There may be spaces between element roots 22 in which an outer edge 23 of hub 104 is exposed. Alternatively, adjacent elements 100 may adjoin one another at roots 22. However, while FIGS. 1-2 illustrate bristles 14 extending from hub 104 such that bristles 14 and hub 104 are coplanar, it is expressly contemplated that bristles 14 may extend from hub 104 at any suitable angle. For example, bristles 14 may extend perpendicularly from hub 104, in some embodiments. In other embodiments, bristles 14 may extend from hub 104 at any angle between 0 and 90°.

Article 10 may be integrally molded such that primary elongate elements 100 and hub 104 are continuous with one another. The connection point between bristles 14 and hub 104, e.g. element root 22, is subject to breakage, resulting in premature wear and reduced service life of surface conditioning article 10.

In one embodiment, article 10 is an abrasive article which comprises a composition of abrasive particles. Abrasive particles may be integrated into bristles 14, coated onto bristles 14, or otherwise embedded into a surface of bristles 14 such that they are available to abrade a surface when abrasive article 10 contacts a surface. While FIG. 1 illustrates an abrasive article that rotates in the rotation direction indicated, it is expressly contemplated that other forms of abrasive article may benefit from embodiments herein, such as vibrating brushes, etc.

Incorporating abrasive particles into, or onto, bristles 14 presents manufacturing challenges as abrasive particles will increase a wear rate of manufacturing components during the manufacturing process of abrasive article 16. For example, abrasive particles may cause wear to any container that holds or transports a molten abrasive particle-resin mixture: or a component extrudes or coats the abrasive particle-resin mixture onto a substrate or into a mold. It is desired to reduce the amount of abrasive-containing material needed to form article 10 to reduce manufacturing wear and tear.

Abrasive articles according to the present disclosure may optionally have elongate abrasive elements that contain combinations of formed abrasive particles along with other abrasive or non-abrasive particles, for example, crushed abrasive particles, filler particles, grinding aids, etc.

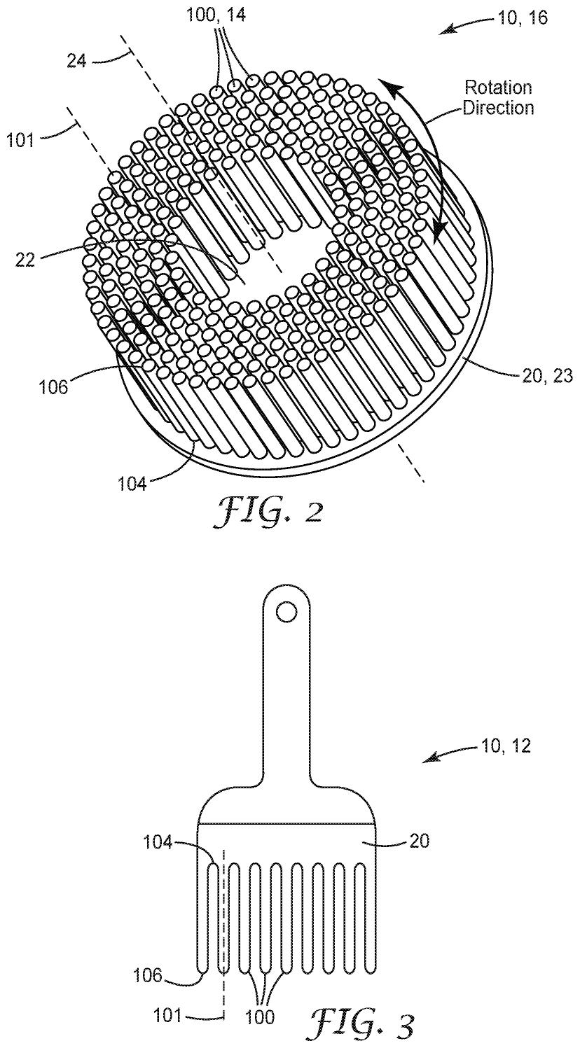

A plurality of articles 10 can be assembled onto main shaft to form an abrasive assembly, akin to what is shown and described with respect to FIGS. 3a and 3b of U.S. Pat. No. 5,903,951 to Ionta et al. Any number of articles 10 may be assembled together to provide an abrasive assembly of any desired width. Preferably, the articles 10 are adjacent one another such that there is essentially no space between the articles. Alternatively, the articles 10 may be assembled onto to a shaft so as to have space between adjacent articles. For example, there may be 5 to 10,000 articles 10 assembled together to form abrasive assembly, although more or less may be used as desired. A means for providing segment-to-segment engagement may be included to reduce or eliminate rotation of adjacent articles relative to one another. Such engagement means can include, for example, an inter-engaging saw tooth pattern or hole and dimple pattern on the surfaces of hub 104.

The materials, manufacturing process and article configuration will depend upon the desired refining application. As used herein, the term “refine” includes at least one of the following: remove a portion of a workpiece surface; impart a surface finish to a workpiece; descale a surface; deburr a surface; clean a workpiece surface, including removing paint or other coatings, gasket material, corrosion, oil residue, or other foreign material or debris; or some combination of the foregoing. In some applications, it may be preferred to provide aggressive abrasive characteristics, in which case the article may comprise abrasive particles, larger size abrasive particles, harder abrasive particles, sharper abrasive particles, more easily fractured abrasive particles, particles shaped for a particular operation, a higher abrasive particle to binder ratio, or some combination of the above. In other applications, it may be preferred to provide a polish type finish to the surface being refined, or to clean a surface without removing surface material itself, in which case the article may employ smaller abrasive particles, softer abrasive particles, lower abrasive particle to binder ratio, or some combination of the above. It is possible to employ formed abrasive particles 200 of varied composition and hardness to obtain the desired abrading characteristics, as well as blends of conventional and formed abrasive particles.

However, it may be possible to achieve desired surface conditioning using an abrasive-free surface conditioning article. For example, a stiffer resin may be sufficient to form bristles able to remove features from, or to clean, a surface. For example, gaskets may be removed from a metal surface using a stiff resin.

In some embodiments herein, abrasive article 10 has a hub 104 from which a number of bristles 14 extend. As illustrated in FIG. 1, in some embodiments, hub 104 is a continuous circumferential portion which is generally planar. However, it may also be possible to have a contoured or curved hub. For example, hub 104 may be convex, concave, or conical in shape. Hub 104 may be, for example, conical, with the primary elongate abrasive elements 100 extending parallel to the conical surface defined by the hub.

Article 10 may optionally have an attachment mechanism as part of hub 104, such as a channel, keyway, or a root to mechanically join several articles together on a drive mechanism (e.g., a shaft) to provide an abrasive assembly. A hub 104 may include one or more mounting holes, through which a locking rod and/or shaft may be inserted. Shaft and/or locking rod(s) may then be attached to a suitable rotary drive mechanism.

Hub 104 can preferably have a thickness of from about 0.5 to 25 mm, more preferably from about 1.0 to 10 mm, still more preferably from about 1.5 to 6 mm, and most preferably from about 1.5 to 3 mm. Hub 104 may be circular as illustrated in FIGS. 1 and 2. The diameter of the outer edge 23 of hub 104 is preferably from about 2.5 to 61.0 cm (1.0 to 24.0 in), although smaller and larger hubs are also within the scope of the invention. In one preferred embodiment, the hub 104 is of a suitable material and thickness to provide a flexible hub 104, which helps maintain more bristles in contact with an uneven or irregular workpiece. The hub 104 preferably is capable of flexing at least 10°, more preferably at least 20°, and still more preferably at least 45° without damage or substantial permanent deformation to the hub. Hub shapes other than circular are also within the scope of the invention, including, but not limited to, oval, rectangular, square, triangular, diamond, and other polygonal shapes, as are relatively rigid or inflexible hubs.

Hub 104 may alternately be a ring sector bounded on each side by radial edges as described in U.S. Pat. No. 5,903,951 to Ionta et al.. Preferably, the ring sector is of an angular width that allows for an integer number of ring sectors to be assembled into a circumferential article. For example, four 90° ring sectors are readily arranged to make a 360° circumferential article.

In some embodiments, hub 104 is molded integrally with the primary elongate abrasive elements 100 to provide a unitary article. Thus, no adhesive or mechanical attachment is required to adhere primary elongate abrasive elements 100 to hub 22. In such embodiments, hub 104 and primary elongate abrasive elements 100 may be molded simultaneously.

Surface conditioning articles in accordance with embodiments herein may be formed in a two-step process, first forming hub 104 and then forming abrasive particle containing bristles 14. However, it is expressly contemplated that the bristles could be molded first, and then the hub molded second. In some embodiments, the hub 22 and bristles 14 are formed using a coinjection process, such that while a first material is still in a flowable state, the second material is injected into the mold. For example, a hub material may be injected after a bristle material, pushing the bristle material into the void spaces of the mold.

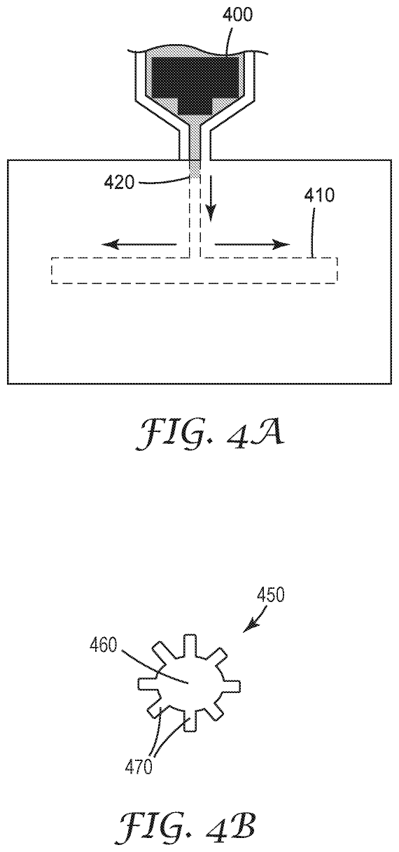

FIGS. 4A and 4B illustrate a first step of an abrasive article formation process. A mixture 400 is provided, through a gate 420 to a mold 410. Material 400 is free of abrasive particles. Material 400 may be a single polymer or other resin, or may be a mixture of polymer or resin materials. Material 400 may be a curable mixture, a molten mixture, or another suitable compound that can be poured, extruded, injected or otherwise fed through gate 420 into mold 410.

A first part 450 may be formed as a result, with a hub portion 460 and, in some embodiments, at least a portion of material 400 may be used to form a portion of elongate abrasive elements 100. As shown in FIG. 4B, bristle connection points 470 extend outward from hub 460.

First part 450, is a unitary structure, in embodiments herein, with a consistent composition across the structure.

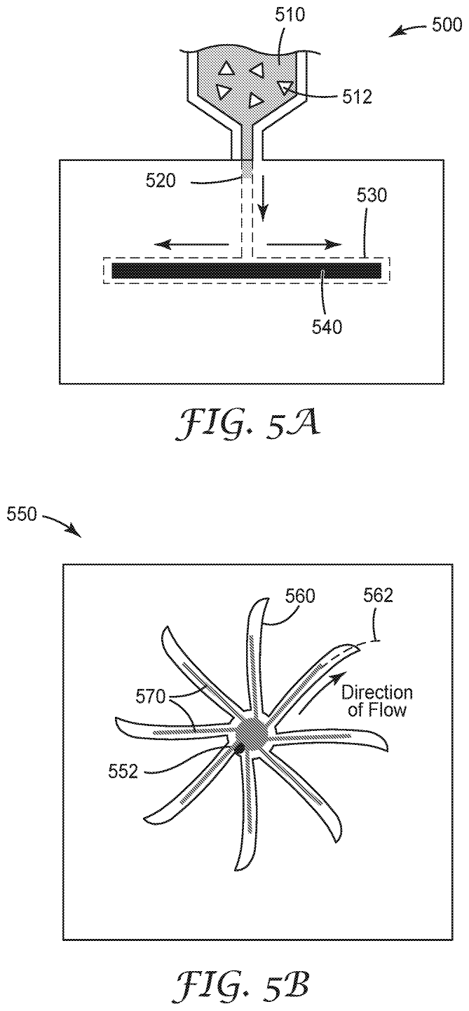

First part 450 may be used in a second mold, as illustrated in FIG. 5A, where a formed unitary hub 540 is placed within a mold 530 such that a material 510, containing abrasive particles 512 can flow through gate 520 and coat first part 540. However, while two separate molds are illustrated and described with respect to FIGS. 4A-4B, it is expressly contemplated that coinjection molding parts or a single mold that receives multiple shots simultaneously or sequentially are all also possible.

However, while FIGS. 5A-5B illustrate a system 500 that fully coats a first part 540 with a second material 510, it is expressly contemplated that second material 510 may only coat a portion of first part 540, e.g. the bristle connection portions 570.

As illustrated in FIG. 5B, bristle connection portions 570 may extend into elongate portions 560 of a second mold 550. Having a first material extend into a bristle-forming portion 560 of mold 550 may allow for performance characteristics to be tailored for a particular application. For example, a first material 400 may have a stiffness factor that reduces a flexibility of resulting bristles. Alternatively, first material 400 may impart other attributes. Additionally, it may improve a bonding between first material 400 and second material 510. This may reduce premature bristle breakage during use.

Material 500 may be a single polymer or other resin, or may be a mixture of polymer or resin materials. Material 500 may be a curable mixture, a molten mixture, or another suitable compound that can be poured, extruded, injected or otherwise fed through gate 520 into mold 510.

In some embodiments, as described herein, first material 400 and second material 510 differ only in that second material 510 includes abrasive particles 512. However, it is also contemplated that first material 400 may have a different composition from second material 510 entirely. However, confining abrasive particles 512 to a second step, in material 510, reduces the amount of abrasive particles 512 running through a system 500, reducing overall wear and tear on system 500.

It is also within the scope of this invention to have two insertions, both containing abrasive particles. The first insertion may have abrasive particles of a certain size, material, and/or hardness, while the second insertion may include different abrasive particles. During abrading, the abrasive particles nearer end or distal end are used first, and then the abrasive particles nearer the proximal end (i.e., nearer the end connected to the hub 22) are used. Primary elongate abrasive elements 100 extend from outer edge 23 of hub 22, beginning at element roots 104 and ending at element ends 106 remote from hub 22. In one preferred embodiment, primary elongate abrasive elements 100 extend radially from the outer edge 23 of the hub 22, and are coplanar with the hub 22. For ease of molding (described more fully below), it may be preferable to have a single row of primary elongate abrasive elements 100 arranged around the outer edge 23. Alternatively, a double row of bristles may be formed. Primary elongate abrasive elements 100 may extend from outer edge 23 of hub 22 in a plane parallel to the plane of hub 22, whether hub 22 is planar or conical or some other shape. Alternatively, primary elongate abrasive elements 100 may extend from outer edge 23 of hub 22 at any oblique angle relative to the applicable plane of the hub.

Primary elongate abrasive elements 100 may have any cross-sectional area A, including but not limited to, circular, star, half moon, quarter moon, oval, rectangular, square, triangular, diamond, or other polygonal shape. In one embodiment, primary elongate abrasive elements 100 comprise a constant cross section along their length. In other embodiments, primary elongate abrasive elements 100 will have a non-constant or variable cross section along their length.

Primary elongate abrasive elements 100 may be tapered such that the cross-sectional area A of the element decreases in the direction away from element root 104 towards element end 106. Tapered primary elongate abrasive elements 100 can have any cross section as described above. Primary elongate abrasive elements 100 may be subjected to bending stresses as article 10 is rotated against a workpiece. These bending stresses may be highest at the element root 104 of primary elongate abrasive elements 100 (at outer edge 23). Therefore, in some embodiments a tapered element is more able to resist bending stresses than an element of constant cross-sectional area A. Primary elongate abrasive elements 100 can have a taper along the entire length, or can have a tapered portion adjacent the element root 104 and a constant cross-sectional area A for the remainder of the element. The taper can comprise any suitable angle. Furthermore, article 10 can include a fillet radius at the transition between element root 104 of element 100 and outer edge 23 of hub 22.

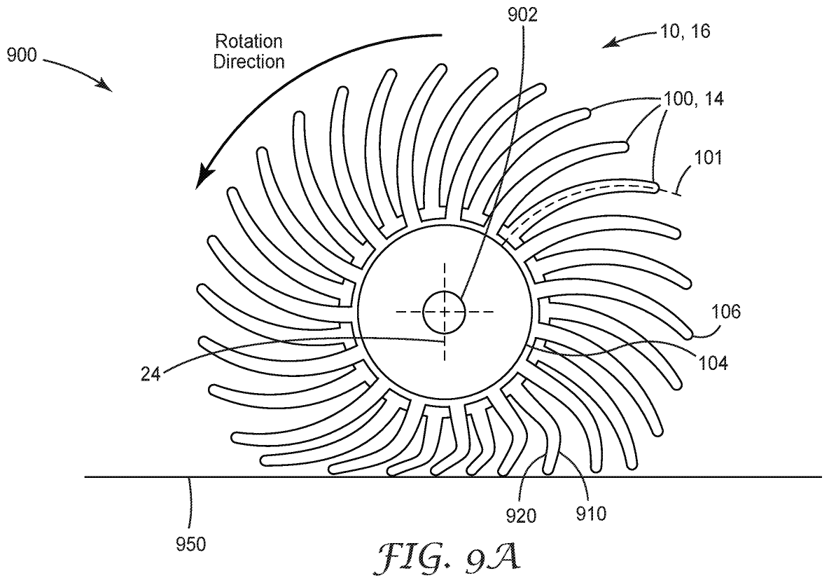

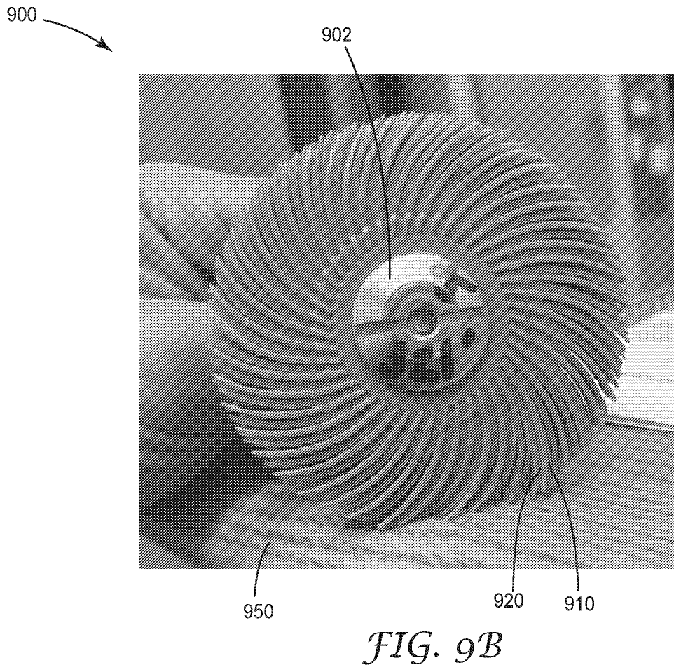

Primary elongate abrasive elements 100 comprise an aspect ratio defined as the length of element 100 measured from outer element root 104 to element end 106, divided by the width of the element. In the case of a tapered element, the width is defined as the average width along the length for purposes of determining the aspect ratio. In the case of non-circular cross section, the width is taken as the longest width in a given plane, such as the comer-to-corner diagonal of a square cross section. The aspect ratio of primary elongate abrasive elements 100 is preferably at least 2, more preferably from about 5 to 100, and still more preferably from about 50 to 75. The size of primary elongate abrasive elements 100 can be selected for the particular application of article 10 and brush. The length of primary elongate abrasive elements 100 is preferably from about 0.2 to 50 cm, more preferably from about 1 to 25 cm, and still more preferably from about 5 to 15 cm. The width of the primary elongate abrasive elements 100 is preferably from about 0.25 to 10 mm more preferably from about 0.5 to 5.0 mm, still more preferably about 0.75 to 3.0 mm, and most preferably from about 1.0 to 2.0 mm. The width of primary elongate abrasive elements 100 can be the same as or different from the thickness of hub 22. In one preferred embodiment, all of the primary elongate abrasive elements 100 have the same dimensions. Alternatively, primary elongate abrasive elements 100 on a brush comprising a plurality of articles 10 may have different dimensions such as different lengths, widths or cross-sectional areas. For example, an article 10 may have two groups of short primary elongate abrasive elements and two groups of long primary elongate abrasive elements, similar to what is shown in FIG. 9 of U.S. Pat. No. 5,903,951 to Ionta et al. Moreover, it is possible to arrange ring sector segments, each having elements of different length. With respect to the brush abrasive assembly, it is possible to employ adjacent articles 10 having different elements. Similarly, in some embodiments, the two different bristle groups vary in hardness (e.g. resin durometer). For example, a “soft” set of bristles may be arranged to alternate with a “hard” set of bristles. Alternating soft and hard bristles may provide for fast finishing/cleaning but nice surface finish.

The density and arrangement of primary elongate abrasive elements 100 can be chosen for the particular application of article 10 and brush. Primary elongate abrasive elements 100 may are arranged uniformly around the outer edge 23 of hub 22. Alternatively, primary elongate abrasive elements 100 can be arranged in groups with spaces between the groups, and can be oriented in the plane of hub 22 other than radially outward, that is, at a non-zero angle relative to the radius of hub 22. Accordingly, article 10 may have a portion of outer edge 23 which does not include any primary elongate abrasive elements 100. The elements may be present over only a portion of outer edge 23 of hub 22, or substantially the entire outer edge 23. Primary elongate abrasive elements 100 may or may not abut adjacent elements as desired.

The material, length, and configuration of the elements are preferably chosen such that primary elongate abrasive elements 100 are sufficiently flexible to aid in refining uneven or irregular workpieces. The primary elongate abrasive elements 100 are preferably capable of bending at least 25°, more preferably at least 45°, still more preferably at least 90°, and most preferably about 180°, without damage or substantial permanent deformation to the elements.

In addition to the potential reinforcement that first material 400 may provide, it is possible to reinforce the primary elongate abrasive elements 100 with any suitable structure. For example, it is possible to place a reinforcing fiber or wire in the element mold cavities, and inject material 400 around the reinforcing wire. This will result in a element 100 having a reinforcing wire or fiber embedded within it.

In one embodiment, the primary elongate abrasive elements 100 are swept back at an angle relative to a radius of the hub in a direction opposite to that of the direction of rotation of the article in operation. Such an arrangement may help to minimize breakage of primary elongate abrasive elements 100 near their root where the bristles join the outer edge 23 of the hub 22. When the article is rotated and the ends of the bristles contact a workpiece, this tends to bend the bristles in a direction opposite to the direction of rotation (as shown in FIG. 9). If this bending force is excessive, an element 100 may break at its root. When an article as described in this embodiment is rotated about an axis perpendicular to the hub 22 and passing through the center of attaching means, the back-swept primary elongate abrasive elements 100 will be subject to centrifugal force. This force will cause the element 100 to bend in a direction towards a radial line. This bending caused by centrifugal force acts opposite to the bending caused by the bristle contacting a workpiece. Therefore, the bristle can withstand a greater amount of bending caused by the workpiece than could a bristle that is initially oriented along the radius. The angle at which elements are swept back is preferably up to 45°, more preferably between about 5° and 35°, still more preferably between about 10° and 30°, and most preferably approximately 22.5°, although other angles may be used as desired. In one embodiment, the hub 22 of the article 10 has an outer diameter at outer edge 23 of approximately 2.5 cm (1 inch) and a thickness of approximately 2.5 mm (0.1 inches), with 30 primary elongate abrasive elements 100 extending outwardly from outer edge 23 in the plane of the hub 22. Each element 100 is approximately 2.25 cm (0.88 inches) long and tapers from approximately 3.0 mm (0.12 inches) thick at the root to approximately 2.0 mm (0.08 inches) thick at the end, with a generally square cross-section. The just-described dimensions of article 10 and number of primary elongate abrasive elements 100 are merely exemplary of one preferred embodiment, the present invention is not thereby limited.

In some embodiments, the primary elongate abrasive elements 100 are at an angle β relative to the plane of the hub 22, as shown and described in FIGS. 21-22 of U.S. Pat. No. 5,903,951 to Ionta et al., the disclosure of which is hereby incorporated by reference in its entirety.

As used herein, the term abrasive particle may include any suitable abrasive particle, including crushed abrasive particles, rod-shaped abrasive particles, formed abrasive particles, partially shaped abrasive particles, precisely shaped abrasive particles, abrasive particle shards, or other suitable abrasive elements.

As used herein, the term “formed abrasive particle” means an abrasive particle that has been deliberately formed such that at least a portion of the abrasive particle has a predetermined shape. Often the shape is replicated from a mold cavity or other tooling used to form the precursor formed abrasive particle. The formed abrasive particle will generally have a predetermined geometric shape that substantially replicates the mold cavity or other form of tooling that was used to form the formed abrasive particle. The cavity or tooling could reside on the surface of an embossing roll or be contained within a flexible belt or production tooling. Alternatively, the formed abrasive particles can be extruded and cut to length or precisely cut from a sheet of dried sol-gel (or other precursor or cured material if not ceramic-based) by a laser beam into the desired geometric shape. Alternatively, the formed abrasive particle may be injection molded or 3D-printed.

A formed abrasive particle has a maximum dimension “M,” a thickness “T” measured normally to the maximum dimension M, a particle axis defined along the maximum dimension M, and a particle plane containing the particle axis and defined normally to the thickness T. As discussed in US Patent Application Publication No. 2022/0016745, published Jan. 20, 2022, in some embodiments the abrasive particles are precisely orientationally aligned along the bristles, such that a particle plane of a first abrasive particle is parallel to a particle plane of a second abrasive particle. In some embodiments, a greater amount of formed abrasive particles are precisely orientationally aligned along the element axis than would occur randomly. In some embodiments, at least 50% of the formed abrasive particles are precisely orientationally aligned along the element axis. In some embodiments, at least 66% of the formed abrasive particles are precisely orientationally aligned along the element axis.

In addition, or in the alternative, to a quantity of formed abrasive particles being precisely orientationally aligned as described above, in some embodiments, formed abrasive particles are generally orientationally aligned along the element axis, as described in U.S. Patent Application Publication No. 2022/0016745, published on Jan. 20, 2022. By “generally orientationally aligned,” it is meant that the particle plane is oriented within 60° of parallel to the element axis. In some embodiments, at least 50% of the formed abrasive particles are generally orientationally aligned along the element axis. In some embodiments, at least 66% of the formed abrasive particles are generally orientationally aligned along the element axis. In some embodiments, at least 75% of the formed abrasive particles are generally orientationally aligned along the element axis. In some embodiments, at least 90% of the formed abrasive particles are generally orientationally aligned along the element axis. In some embodiments, at least 95% of the formed abrasive particles are generally orientationally aligned along the element axis. In some embodiments, at least 96% of the formed abrasive particles are generally orientationally aligned along the element axis.

As can be understood from the above, a formed abrasive particle that is precisely orientationally aligned will also be generally orientationally aligned, while a formed abrasive particle that is generally orientationally aligned is not necessarily also precisely orientationally aligned. In one embodiment, at least a majority of the formed abrasive particles are precisely orientationally aligned, and at least 75% of the formed abrasive particles are generally orientationally aligned. In one embodiment, at least a majority of the formed abrasive particles are precisely orientationally aligned, and at least 90% of the formed abrasive particles are generally orientationally aligned. In one embodiment, at least a majority of the formed abrasive particles are precisely orientationally aligned, and at least 95% of the formed abrasive particles are generally orientationally aligned. In one embodiment, at least 66% of the formed abrasive particles are precisely orientationally aligned, and at least 95% of the formed abrasive particles are generally orientationally aligned.

In addition to, or in conjunction with, the embodiments described above where formed abrasive particles are generally and/or precisely orientationally aligned, in some embodiments the particle axis of at least 40% of the formed abrasive particles is within 5° of parallel to the element axis 101, and/or the particle axis of at least 60% of the formed abrasive particles is within 10° of parallel to the element axis.

It should be understood that the aforementioned combinations are merely exemplary, and that any combination of applicable ranges may be selected within the scope of the present disclosure.

Orientation of formed abrasive particles within an elongate abrasive element may be accomplished by any means capable of resulting in the degree and frequency of orientation described herein. The following methods or orientation are exemplary and not intended to be limiting. For example as described in US Patent Application Publication 2022/0016745, published Jan. 20, 2022.

The hub 22 may further comprise a reinforcing feature, such as a fiber reinforcing substrate. Reinforcing means can comprise, for example, fabric, non-woven sheeting, mat, mesh, scrim, and the like, or can comprise individual fibers compounded into the moldable polymer and dispersed throughout the article. The reinforcing means may optionally contain a treatment to modify its physical properties. The purpose of the reinforcing means is to increase the flexural strength and tensile strength of the article 10, and decreasing crack propogation. Examples of reinforcing fibers suitable for use in the present invention include glass fibers, metal fibers, carbon fibers, wire mesh, mineral fibers, fibers formed of heat resistant organic materials, thermoplastic or thermoset fibers, or fibers made from ceramic materials. Reinforcing fibers can also have an adhesion promoter or compatibilizing agent on the surface of the fiber. Other organic fibers include polyvinyl alcohol fibers, nylon fibers, polyester fibers and phenolic fibers. In some embodiments, the moldable polymer mixture may preferably contain a coupling agent, such as a silane coupling agent, a phosphate coupling agent, a ziconate coupling agent or a titanate adhesion promoter to improve the adhesion to the thermoplastic material.

Materials 400 and 510 may be any suitable material that can be molded, extruded or otherwise shaped as described in embodiments herein. Material 400 may be the same as, or different, from material 510.

Material 400 and/or material 510 may include a moldable polymer material (included in either or both of materials 400 and 510), where employed, may be an organic binder material that is capable of being molded, i.e., it is capable of deforming under heat to form a desired shape. The moldable polymer may be a thermoplastic polymer, a thermosetting polymer, a thermoplastic elastomer, or combinations thereof. In the case of a thermoplastic polymer, the organic binder is heated above its melting point which causes the polymer to flow. This results in the thermoplastic polymer flowing into the cavities of the mold to form the article 10. The article is then cooled to solidify the thermoplastic binder. In the case of reactive injection molding, a thermosetting polymer, during molding the organic binder is in a thermoplastic state, i.e., after it is heated above its melting point it will flow into the cavities of the mold to form the article. The organic binder then crosslinks at ambient or elevated temperatures. Examples of suitable thermosetting polymers include styrene butadiene rubber, polyurethane, urea-formaldehyde, epoxy, and phenolics.

Material 400 and/or material 510 may include a thermoplastic polymer. Examples of suitable thermoplastic polymers include polycarbonate, polyetherimide, polyester, polyethylene, polysulfone, polystyrene, polybutylene, acrylonitrile-butadiene-styrene block copolymer, polypropylene, acetal polymers, polyurethanes, polyamides, and combinations thereof. In general, preferred thermoplastic polymers of the invention are those having a high melting temperature and good heat resistance properties. Thermoplastic polymers may be preferably employed for low speed applications of article 10, in which stress during operation is relatively low. Examples of commercially available thermoplastic polymers suitable for use with the present invention include GRILON CR9 copolymer of NYLON 6,12 available from EMS-American Grilon, Inc., Sumter, South Carolina.

One particular thermoplastic polymer suitable for use in embodiments herein is a polyamide resin material, which is characterized by having an amide group, i.e., —C(O)NH—. Various types of polyamide resin materials, i.e., NYLONS can be used, such as NYLON 6/6 or NYLON 6. NYLON 6/6 is a condensation product of adipic acid and hexamethylenediamine. NYLON 6/6 has a melting point of about 264° C. and a tensile strength of about 770 kg/cm². NYLON 6 is a polymer of ε-caprolactam. NYLON 6 has a melting point of about 220° C. and a tensile strength of about 700 kg/cm². Examples of commercially available NYLON resins useable as backings in articles according to the present invention include “VYDYNE” from Ascend Performance Materials, Houston, TX. “ZYTEL” and “MINION” both from Du Pont, Wilmington, Del. “TROGANMID” from Evonik, Allentown, PA, and “ULTRAMID” from BASF Corp., Parsippany, N. J.

Material 400 and/or material 510 may include a thermoplastic elastomer. For example, for high speed, high stress applications, it is preferred that the moldable polymer is a thermoplastic elastomer or includes a thermoplastic elastomer. Thermoplastic elastomers (or “TPE” s) are defined and reviewed in Thermoplastic Elastomers, A Comprehensive Review, edited by N. R. Legge, G. Holden and H. E. Schroeder, Hanser Publishers, New York, 1987 (referred to herein as “Legge et al.”, the entire disclosure of which is incorporated by reference herein). Thermoplastic elastomers (as used herein) are generally the reaction product of a low equivalent weight polyfunctional monomer and a high equivalent weight polyfunctional monomer, wherein the low equivalent weight polyfunctional monomer has a functionality of at most about 2 and equivalent weight of at most about 300 and is capable on polymerization of forming a hard segment (and, in conjunction with other hard segments, crystalline hard regions or domains) and the high equivalent weight polyfunctional monomer has a functionality of at least about 2 and an equivalent weight of at least about 350 and is capable on polymerization of producing soft, flexible chains connecting the hard regions or domains. “Thermoplastic elastomers” differ from “thermoplastics” and “elastomers” (a generic term for substances emulating natural rubber in that they stretch under tension, have a high tensile strength, retract rapidly, and substantially recover their original dimensions) in that thermoplastic elastomers, upon heating above the melting temperature of the hard regions, form a homogeneous melt which can be processed by thermoplastic techniques (unlike elastomers), such as injection molding, extrusion, blow molding, and the like. Subsequent cooling leads again to segregation of hard and soft regions resulting in a material having elastomeric properties, however, which does not occur with thermoplastics. Thermoplastic elastomers combine the processability (when molten) of thermoplastic materials with the functional performance and properties of conventional thermosetting rubbers (when in their non-molten state), and which are described in the art as ionomeric, segmented, or segmented ionomeric thermoplastic elastomers. The segmented versions comprise “hard segments” which associate to form crystalline hard domains connected together by “soft”, long, flexible polymeric chains. The hard domain has a melting or disassociation temperature above the melting temperature of the soft polymeric chains.

Commercially available thermoplastic elastomers include segmented polyester thermoplastic elastomers, segmented polyurethane thermoplastic elastomers, segmented polyamide thermoplastic elastomers, blends of thermoplastic elastomers and thermoplastic polymers, and ionomeric thermoplastic elastomers. “Segmented thermoplastic elastomer”, as used herein, refers to the sub-class of thermoplastic elastomers which are based on polymers which are the reaction product of a high equivalent weight polyfunctional monomer and a low equivalent weight polyfunctional monomer. Segmented thermoplastic elastomers are preferably the condensation reaction product of a high equivalent weight polyfunctional monomer having an average functionality of at least 2 and an equivalent weight of at least about 350, and a low equivalent weight polyfunctional monomer having an average functionality of at least about 2 and an equivalent weight of less than about 300. The high equivalent weight polyfunctional monomer is capable on polymerization of forming a soft segment, and the low equivalent weight polyfunctional monomer is capable on polymerization of forming a hard segment. Segmented thermoplastic elastomers useful in the present invention include polyester TPEs, polyurethane TPEs, and polyamide TPEs, and silicone elastomer/polyimide block copolymeric TPEs, with the low and high equivalent weight polyfunctional monomers selected appropriately to produce the respective TPE.

The segmented TPEs preferably include “chain extenders”, low molecular weight (typically having an equivalent weight less than 300) compounds having from about 2 to 8 active hydrogen functionality, and which are known in the TPE art. Particularly preferred examples include ethylene diamine and 1,4-butanediol.

“Ionomeric thermoplastic elastomers” refers to a sub-class of thermoplastic elastomers based on ionic polymers (ionomers). Ionomeric thermoplastic elastomers are composed of two or more flexible polymeric chains bound together at a plurality of positions by ionic associations or clusters. The ionomers are typically prepared by copolymerization of a functionalized monomer with an olefinic unsaturated monomer, or direct functionalization of a preformed polymer. Carboxyl-functionalized ionomers are obtained by direct copolymerization of acrylic or methacrylic acid with ethylene, styrene and similar comonomers by free-radical copolymerization. The resulting copolymer is generally available as the free acid, which can be neutralized to the degree desired with metal hydroxides, metal acetates, and similar salts. A review of ionomer history and patents concerning same is provided in Legge et al., pp. 231-243.

“Thermoplastic polymer”, or “TP” as used herein, has a more limiting definition than the general definition, which is “a material which softens and flows upon application of pressure and heat.” It will of course be realized that TPEs meet the general definition of TP, since TPEs will also flow upon application of pressure and heat. It is thus necessary to be more specific in the definition of “thermoplastic” for the purposes of this invention. “Thermoplastic” as used herein, means a material which flows upon application of pressure and heat, but which does not possess the elastic properties of an elastomer when below its melting temperature.

Blends of TPE and TP materials are also within the invention, allowing even greater flexibility in tailoring mechanical properties of the abrasive filaments of the invention. A range of hardness may be 20-100 durometer Shore D.

Commercially available and preferred segmented polyesters include those known under the trade designations “HYTREL 4056”, “HYTREL 5526”, “HYTREL 5556”, “HYTREL 6356”, “HYTREL 7246”, and “HYTREL 8238” available from E. I. Du Pont de Nemours and Company, Inc., Wilmington, Del., with the most preferred including HYTREL 5526, HYTREL 5556, and HYTREL 6356. A similar family of thermoplastic polyesters is available under the tradename “RITEFLEX” (Hoechst Celanese Corporation). Still further useful polyester TPEs are those known under the trade designations “ECDEL” from Eastman Chemical Products, Inc., Kingsport, Tenn. “ARNITEL” from DSM Engineered Plastics: and “BEXLOY” from Du Pont. Further useful polyester TPEs include those available as “LUBRICOMP” from SABIC, Exton, Pa., and is commercially available incorporating lubricant, glass fiber reinforcement, and carbon fiber reinforcement.

Commercially available segmented polyamides include those known under the trade designation “PEBAX” and “RILSAN” both available from Arkema, King of Prussia, PA.

Commercially available segmented polyurethanes include those known under the trade designation “ESTANE”, available from Lubrizol, Brecksville, Ohio. Other segmented polyurethanes include those known under the trade designations “PELLETHANE”, and “ISOPLAST” from The Dow Corning Company, Midland, Mich.,: and those known under the trade designation “ELASTOLLAN” from BASF Corporation.

Thermoplastic elastomers are further described in U.S. Pat. No. 5,427,595 (Pihl et al.), and assigned to the assignee of the present application, the entire disclosure of which is incorporated herein by reference.

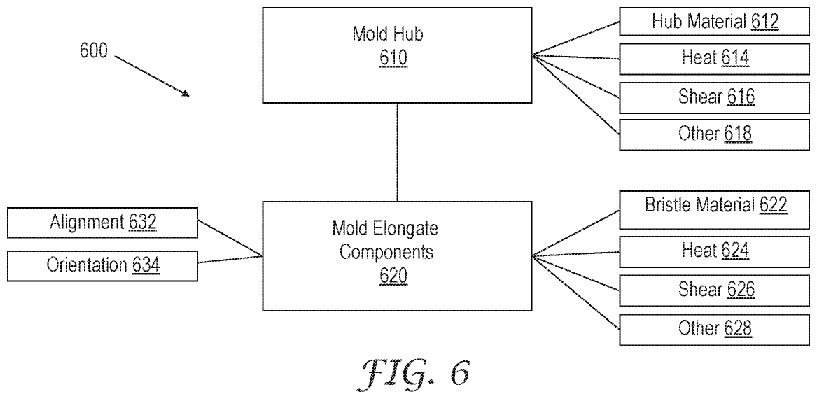

FIG. 6 illustrates a method of forming an abrasive article in accordance with embodiments herein. Method 600 may be used to make any of the abrasive articles 10 illustrated in FIGS. 1-3.

In block 610, a hub is molded. The hub may be molded from a hub material 612, which may be any suitable polymer material, such as a thermoplastic polymer, a thermosetting polymer, a thermoplastic polymer or a thermoplastic elastomer.

Hub material 612 may be molded using a metal form, for example. Material 612 is heated, as indicated in block 614 to a molten or near molten state and then moved into the metal form. Material 612 may be injection molded, extruded or otherwise fed into a mold. A shear force 616 may be applied, for example by an extruder. The hub is then allowed to cool such that it can be removed from the metal form. Other steps 618 may also be included, such as mixing of one or more components to form hub material 612, or other steps.

In block 620, the elongate components (e.g., bristles) are molded. A bristle material 622 may include any suitable polymer or resin material mixed with abrasive particles. As described herein, the abrasive particles may be crushed, formed, shaped or other suitable abrasive particles. Material 622 may be heated, as indicated in block 624, or have shear force imparted, as indicated in block 626, for example using an extruder. Other steps 628 may also be taken. For example, the abrasive particles may undergo an alignment 632 or orientation 634 step. For example, electrostatic or magnetic alignment processed may be used, as described in Published PCT Applications: WO 2018/080703, WO 2018/080755, WO 2018/136268, WO2019/207415, WO2019/207416, WO2019/207417, WO2019/079331, WO2019/074768 and WO2020/261112.

Alignment or orientation may also be accomplished by depositing elongate material as a slurry of liquid (e.g., molten or uncured) material and abrasive particles may be extruded from a die in such a manner that the flow of the liquid binder through the die along a flow axis is adapted to orient the abrasive particles along the direction of liquid flow. Thereafter, the elongate material may be cooled and/or cured to form an elongate abrasive element with abrasive particles that are orientationally aligned along an element axis.

Alternatively, elongate component material 622 may be provided as a slurry of liquid (e.g., molten or uncured) binder with abrasive particles, which may be injected into an elongate mold cavity in such a manner that the flow of the liquid binder through the elongate cavity along a flow axis is adapted to orient the abrasive particles along the direction of liquid flow. Thereafter, the material 622 may be cooled and/or cured to form an elongate abrasive element comprising formed abrasive particles that are orientationally aligned along an element axis.

Alternatively, elongate component material 622 may be provided as a slurry of liquid (e.g., molten or uncured) binder and abrasive particles may be deposited into an elongate mold cavity 300, wherein the formed abrasive particles are themselves magnetizable and/or comprise a magnetizable surface coating. The slurry thus deposited can be subjected to a magnetic field adapted to orientationally align the formed abrasive particles. The abrasive particles may by this method be orientationally aligned along the elongate dimension of the mold cavity (or optionally along another dimension as dictated by interaction with the magnetic field). Thereafter, the binder may be cooled and/or cured to form an elongate abrasive element comprising formed abrasive particles that are orientationally aligned along an element axis.

Alternatively, elongate component material 622 may be provided as a slurry of liquid (e.g., molten or uncured) binder 220 and formed abrasive particles 200 may be deposited into an elongate mold cavity 300, wherein the formed abrasive particles are themselves magnetizable and/or comprise a magnetizable surface coating. The slurry thus extruded (or while still present in the mold) can be subjected to a magnetic field adapted to orientationally align the formed abrasive particles. The formed abrasive particles may by this method be orientationally aligned along the elongate dimension of the resulting elongate abrasive element (or optionally along another dimension as dictated by interaction with the magnetic field). Thereafter, the binder may be cooled and/or cured to form an elongate abrasive element comprising abrasive particles that are orientationally aligned along an element axis.

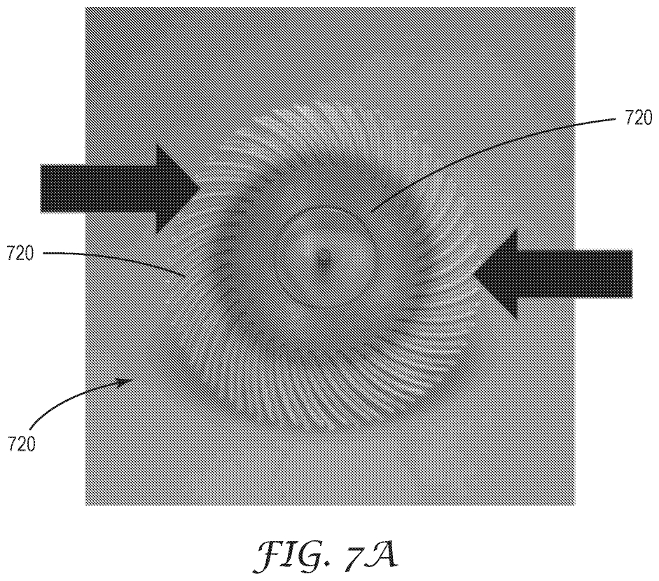

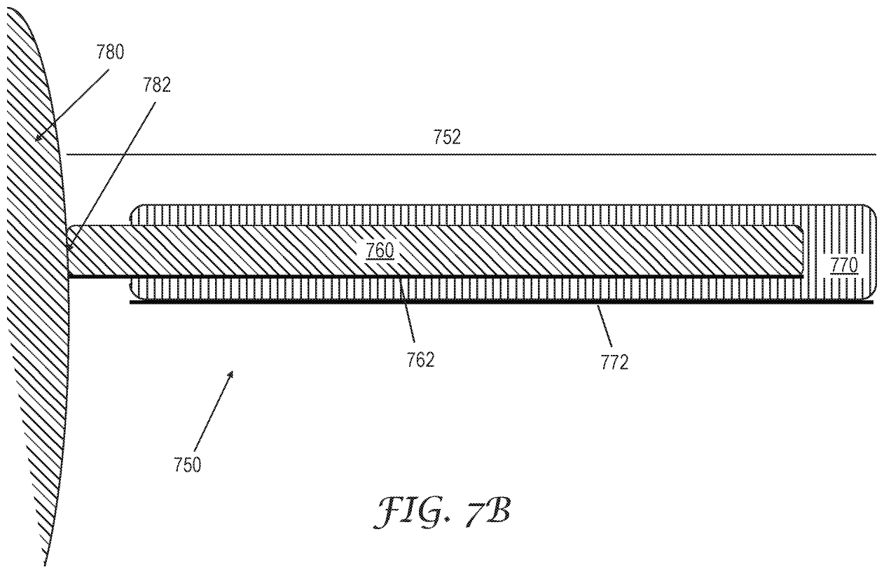

FIGS. 7A-7B illustrate abrasive articles with elongate components in accordance with embodiments herein. FIG. 7A illustrates an abrasive article 700 that includes a hub 710 made of a first material that is free of abrasive particles. The first material may be a stiffer or stronger material. As illustrated in FIG. 7, the first material extends into the bristles. This may help to reduce bristle breakage.

Abrasive article also includes a number of bristles 720 formed of a second material. The second material may be a polymer or polymer resin with abrasive particles. The second material may extend substantially the entire length of bristles 720, only halfway along bristles 720, or another portion based on desired properties of the final abrasive article.

In some embodiments, abrasive article 700 is formed by co-injection, which allows for a strong bond between hub material 710 and bristle material 720. This creates an integral bond between the bristles 720 and hub 710, reducing premature bristle breakage. However, other manufacturing processes may also be suitable. For example, an overmolding process may be used in some embodiments. Additionally, it may be suitable to have a chemical bond between material 710 and material 720, in some embodiments. A mechanical bond may also be suitable between material 720 and 720, for example protrusions on material 710, a lock and key structure, or other suitable options.

FIG. 7B illustrates a schematic of a bristle 750 extending from a hub 780. Hub 780 is formed of a first material 760, which extends at least partway into bristle 750. Bristle 750 has a bristle length 752, measured as extending from a connection point 782 to the hub to an end. First material 760 and second material 770, both extend at least partway along bristle length 752.

As illustrated in FIG. 7B, a first material 760 extends from a hub connection point 782 toward an end of bristle 750. However, in the embodiment of FIG. 7B, first material 760 does not extend 100% of the way to an end of bristle 750. In some embodiments, first material 760 only extends 10%, or only 20% or only 25% of the length 752. In other embodiments, however, first material 760 extends along substantially the entire length of bristle 750, for example at least 80% of length 752, at least 90% of length 752 or at least 95% of length 752. It may also be suitable, for some applications, for first material 760 to extend closer to halfway between connection point 782 and a full length 752, for example such that length 762 is at least 30%, at least 40%, at least 50%, at least 60% or at least 70% of length 752.

A second material 770, covers a length 772 of bristle 750. Second material 770 contains abrasive particles. Second material 770 may have the same, or a different polymer or resin as first material 760 in addition to the abrasive particles. Second material 770 may be bonded to first material 760 in any suitable manner, e.g. chemical bond, mechanical bond, etc. Second material 770 may be deposited over first material 760 using overmolding, injection molding or any other suitable lamination procedure. As illustrated in FIG. 7B, in some embodiments material 770 extends along a portion of bristle length 752. Second material may extend along more than half of bristle length 752, for example at least 50%, at least 60%, at least 70%, at least 80% or at least 90% of bristle length 752. In some embodiments, second material 770 may actually extend along the entire bristle length 752, or even cover part of hub 780, such that second material extends over 100% of bristle length 752. However, in some embodiments, second material 770 covers less than half the bristle length 752, for example less than 50%, less than 40%, less than 30% or less than 20% of bristle length 752.

Using a multi-shot injection molding method a radial bristle disc could be made having a central hub with a different resin composition, or different properties, than the bristles extending therefrom. This could reduce cost as well as create a more durable product. In some prior art products, HYTREL® resins (available from DUPONT®) are used due to their superior flex fatigue properties. This allows the bending of the bristles during use without breaking. Other resin types have been shown to be more wear resistant and provide a better cut rate, but experience premature bristle breakage after too much flexing. In some embodiments, the central hub and base of the bristle could be made out of different thermoplastic elastomers. For example, the hub portion, and potentially a portion of each bristle (e.g. a bristle connecting portion) could be formed using a flex fatigue resistant material, such as a polyester(Hytrel®, for example) and the bristles could be made out of a tougher, wear resistant material, such as a polyamide (e.g. Vestamid®, for example). The bristle connecting portion may extend at least 5% of the bristle length, at least 10% of the bristle length, at least 20% of the bristle length, at least 30% of the bristle length, at least 40% of the bristle length, or up to 50% of the bristle length.

In some embodiments, a first resin (e.g. abrasive-free, hub-forming material) is more flexible, with a higher flex fatigue resistance than a second resin. In some embodiments, a second resin (e.g. abrasive containing, bristle-forming material) is-abrasion resistant, toughened, low wear, has a higher stiffness and is more heat resistant than the first resin.

The first and second resin, however, may both be made using all the same type of resin or, in some embodiments, the same base material with different performance enhancers added, for example lubricant, grinding aid, polishing agent and/or reinforcing materials. In other embodiments, the first and second materials are selected for their advantageous properties.

An outer sheath containing the mineral is, in some embodiments, a harder, wear resistant resin while the inside core of the bristle may or may not contain mineral and is a softer material with good flex fatigue properties to keep the bristle from breaking prematurely.

Most often, bristle breakage happens at the base of the bristle, at a hub connection point. In a two-shot injection molding method, a reinforced hub and bristle base can be formed. In some embodiments herein, a hub of the bristle product is reinforced with a filler component. The filler could be a scrim, chopped fiber, nonwoven etc.

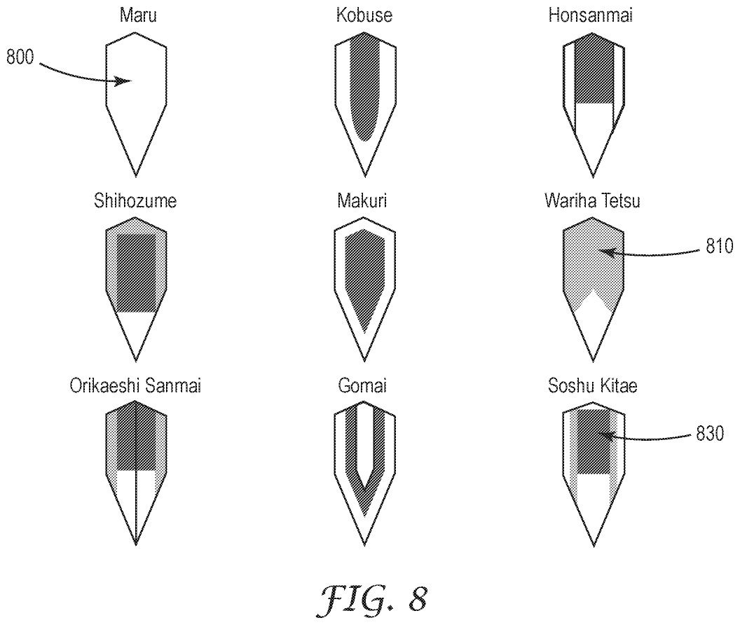

FIG. 8 illustrates lamination patterns that may be used in accordance with embodiments herein. The bristles may be formed using concepts from Samurai sword composition. FIG. 8 illustrates different lamination patterns that can be made with three different materials. In samurai sword construction, steel of three different hardness levels may be used, hard steel 800, medium steel 810, and soft steel 820.

By laminating different types of steel, different properties were achieved. Similarly, by using co-injection methods as described herein, it may be possible to achieve more complex lamination patterns with two or more materials, to achieve abrasive articles suitable for a range of operations.

A construction of the bristle could have additional performance advantages if it were similar to the construction of a Samurai sword composition. For example, the Kobuse or Wariha Tetsu constructions are imagined to be most useful because of their manufacturability, a core and good working/abrading layer. A trailing edge of the bristle can, in some embodiments, be reinforced with a material that is different from the material on the leading edge, which does most of the abrading. The trailing material could have a higher modulus imparting stiffness to the bristle while the leading-edge material may be softer to give a desirable finish on the workpiece.

In a separate construction the trailing edge could be a softer, more flexible material which is flex fatigue resistant while the leading edge is harder, wear resistant and give a higher cut rate RBD product.

FIG. 9 illustrates an abrasive article in operation in accordance with embodiments herein. Abrasive article 900 is pressed against a workspace 950 by a downward force 902. Abrasive article 900 rotates against workpiece 950, such that a leading edge 910 contacts worksurface 950.

In some embodiments, a combi-type radial bristle disc is made using multi-shot injection molding. A subsegment of the bristles contain a resin with property set 1 and the rest of the bristles contain a resin with a property set 2. Such a disc may be similar to a combi flap disc or wheel where alternating flaps are made out of coated abrasive and nonwoven abrasive materials. In some embodiments, alternating (or in some integer) bristles would have various compositions. For example, the resin properties may differ between groups of bristles, or even the mineral size and/or mineral properties may differ. This could give the RBD a “soft” feel and nice finish but a high cut rate combination reducing process steps at the end user.

In some embodiments, a stiffness varies along the length of the fiber, with a higher stiffness at the hub-connecting end of the bristle. Such a construction may be useful for sensing an end of RBD life in a robotic cell. As the bristles wear down in length, they become stiffer. A robotic abrading system can sense the change in stiffness via strain gauges or the like, and know it was time to change to a new product or when to make an adjustment for more optimal abrading such as increasing abrasive RPM, force, etc.

In some embodiments, a first and second resin type can be selected with different thermal shrinkage rates, which can induce a curved shape to bristles. Similarly, in some embodiments, bristles are formed with a curl, such that, as the abrasive article cools, a three-dimensional bristle is formed that has curvature in multiple planes.

In some embodiments, bristles are formed with one or more annular reinforcements. Annular reinforcement(s) may be placed along a length of the bristle, e.g. at a distance X from the tip. The annular support may be a spiral shape, for example. Various elasticity of annual support may provide a bristle with more or less amenable to flexing.

Using techniques herein, abrasive articles can be formed with a variety of bristle shapes and physical properties. For example, the abrasive article may have bristles including material to provide end-of-life indication using a variety of mechanisms: sound, vibration, color, electrical continuity, heat, etc., for example as described in U.S. Provisional Patent Applications with Ser. Nos. 63/366,802, 63/366803, and 63/366806, all filed on Jun. 22, 2022.

In some embodiments, surface conditioning articles described herein include attributes that induce breakdown at a specific locations along the bristles. This could include, for example, a notch in the molded bristle side wall, micro or macro textures in specific locations along the length of the bristle portion of the mold, as well as one or more slits or cuts.

Depending on a shape, location and size of the introduced feature, breakdown of the bristles can occur without full failure of the surface conditioning article. In embodiments where the bristles include abrasive particles, the breakdown could allow for new mineral to be exposed and profile of the molded part to be refreshed.

Additionally, while the induced feature could be molded into the bristles, it is expressly contemplated that secondary processing such as laser, surface treatment, die cutting or other processing can be done to a molded surface conditioning articles after the initial molding process.

In some embodiments, microreplication or specific mold texture may be included such that polymer flow & freezing off is improved, potentially eliminating/reducing knit lines or flow fronts.

In some embodiments the abrasive article is formed using insert molding. This could be completed, for example, by introducing a sheet of material (film, nonwoven, etc.) with mineral into the mold cavity, close the mold and mold the resin around it. The resin could be introduced in one or more sides.

Additionally, while many examples are described herein as formed using coinjection molding, it is also expressly contemplated that, in some embodiments, overmolding us used to obtain bristles with multiple resin layers. After a first resin is shot into a mold, for example, a second resin is shot over the first resin in specific regions or over the entire part.

In some embodiments, a highly reflective polymer is used in either the hub-forming material or the bristle-forming material. Such an abrasive article can be used in combination with a light source to better illuminate the workpiece while grinding. The highly reflective polymer may be included as an additive such that the hub-forming material or the bristle-forming material is a mixture. For example, metallic powder or particles could be added, such as titanium oxide. Glass powder may also add reflectivity. Some reflective thermoplastic polyurethane elastomers are also reflective.

A single abrasive article 10 is described herein, and illustrated in FIG. 1, 7A and 9, for example. However, it is expressly contemplated that a brush is formed by stacking multiple abrasive articles 10.

Article 10 may include an attachment means as generally shown and described, for example, in U.S. Pat. No. 5,903,951. For example, several articles may be joined together to form an assembly as described therein, and/or one or more articles 10 may be attached to a support means such as a separate hub or shaft as described therein. Hub 22 may comprise an inner edge configured to engage with such a shaft, and/or may also (or alternatively) include mounting holes for accepting one or more locking rods. Hub 22 may include a channel or keyway configured to engage a suitably configured key in a shaft. As further described therein, hub 22 may be continuous, and not include an opening defined by an inner edge. An attachment means may be provided at the center of hub 22. This type of attachment means is suitable for use with 360° circular articles. Suitable attachment means are described in U.S. Pat. Nos. 3,562,968; 3,667,170; and 3,270,467 the entire disclosures of all of which are incorporated herein by reference. One preferred attachment means is the integrally-molded threaded stud adapted for screw-type engagement with a rotary tool as taught by U.S. Pat. No. 3,562,968. In such embodiments, it is preferred that the attachment means is molded integrally with the hub 22 and is centered relative to the hub 22 for proper rotation of article 10. The attachment means may be made from the same material as the rest of the article 10, and may contain abrasive particles. Alternatively, the attachment means may be made from a separate injection of binder 220 with or without abrasive particles.

In other embodiments, however, a hook and loop type attachment is present on hub 22 to attach the article 10 to a back-up pad of a power rotary tool. Suitable hook-and loop fasteners include those taught in U.S. Pat. No. 5,077,870, “Mushroom-Type Hook Strip for a Mechanical Fastener,” (Melbye et al.), incorporated herein by reference, or of the type commercially available as SCOTCHMATE™ from 3M Company, St. Paul, Minn. It is also possible to use a hermaphroditic fastener such as DUAL LOCK™M fastener, available from 3M Company, to secure the molded article to a back up pad. It is also possible to employ intermeshing structured surfaces such as taught in U.S. Pat. No. 4,875,259, “Intermeshing Articles” (Appeldorn), incorporated herein by reference.

It is also within the scope of the present invention to use an attachment system where either the hub of the molded article or the back-up pad of the drive tool includes a layer of pressure sensitive adhesive, while the other of the article or back-up pad comprises a surface to which the pressure sensitive adhesive may releasably attach with the desired attachment strength. Examples of suitable pressure sensitive adhesives include latex crepe, rosin, acrylic polymers and copolymers such as polybutylacrylate and polyacrylate ester, vinyl ethers such as polyvinyl n-butyl ether, alkyd adhesives, rubber adhesives such as natural rubber, synthetic rubber, chlorinated rubber, and mixtures thereof. The adhesive is selected to provide the desired attachment characteristics. One preferred surface to which the abrasive may be releasably affixed is a vinyl sheet.

Alternatively, the hub of the molded article may contain one or more straight or threaded holes or openings so that the abrasive article may be mechanically secured (such as with a bolt and nut) to the back up pad. Such a hole may optionally be fitted with an insert of a different material from that of the central portion of the molded article.

In some embodiments, an interlocking attachment mechanism is present within each hub material. This allows for abrasive articles 10 to be stacked, such that layers of molded bristles together to create a brush. The interlocking mechanism allows the brush to rotated in unison. During acceleration and deceleration, significant forces can be introduced to the individual bristles. Creating an alternate coupling mechanism could allow the bristle plates to couple during rotation for working against a part and decouple during deceleration (changing localized forces).

Other configurations of abrasives brushes, bristle, and/or filaments are described in, for example, U.S. Pat. No. 5,045,091 (Abrahamson et al.); U.S. Pat. No. 5,233,719 (Young et al.); U.S. Pat. No. 5,400,458 (Rambosek); U.S. Pat. Nos. 5,679,067 and 5,903,951 (Ionta et al.); 5,427,595 (Pihl et al.): U.S. Pat. No. 5,460,883 (Barber et al.); U.S. Pat. No. 3,618,154 (Muhler et al.); and U.S. Pat. No. 3,233,272 (Pambello).

Abrasive particles generally include crushed abrasive grain, formed abrasive particles, and/or precisely formed abrasive particles. Examples of basic formed abrasive particles are described in U.S. Pat. Nos. 5,201,916 (Berg et al.) and 5,366,523 (Rowenhorst et al.), where it is generally disclosed that such particles could be used in abrasive brushes. Examples of precisely formed abrasive particles include CUBITRON II™ (available from 3M Company, St. Paul, MN). Examples of precisely formed abrasive particles are also described in U.S. Pat. No. 8,142,531 (Adefris et al.); U.S. Pat. No. 8,728:185 (Adefris), where it is generally disclosed that such particles could be used in abrasive brushes. Other useful formed abrasive particles are disclosed in U.S. Provisional Application No. 62/669,568 to Mevissen et al. (“Abrasive Articles Including Soft Shaped Abrasive Particles”), the disclosure of which is incorporated herein by reference.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

A surface conditioning article is presented that includes a hub portion with a first material. The first material is free of abrasive particles. The article also includes a plurality of elongate abrasive elements, each extending along an element axis, and each of the primary elongate abrasive elements includes a second material.

The surface conditioning article may be implemented such that the second material includes a plurality of abrasive particles.

The surface conditioning article may be implemented such that the abrasive particles are crushed abrasive particles, formed abrasive particles, partially shaped abrasive particles, precisely shaped abrasive particles or abrasive particle shards.

The surface conditioning article may be implemented such that the first material includes a polymer and the second material also includes the polymer.

The surface conditioning article may be implemented such that the first material includes a first polymer and the second material includes a second polymer, different from the first polymer.

The surface conditioning article may be implemented such that the first material or the second material include a filler material.

The surface conditioning article may be implemented such that the filler material includes a scrim, fiber, particles, or a nonwoven material.

The surface conditioning article may be implemented such that the plurality of elongate elements also include a third material.

The surface conditioning article may be implemented such that each of the plurality of elongate elements include the first material and the second material couples to the first material.

The surface conditioning article may be implemented such that the second material is overmolded over the first material.

The surface conditioning article may be implemented such that the second material is injection molded over the first material.

The surface conditioning article may be implemented such that the second material is chemically or mechanically bonded to the first material.

The surface conditioning article may be implemented such that each of the elongate elements has a length, and the first material includes a first material length that is less than the length.

The surface conditioning article may be implemented such that each of the elongate elements has a length, and the second material includes a second material length that is less than the length.

The surface conditioning article may be implemented such that the second material length is more than 50% of the length.

The surface conditioning article may be implemented such that the second material is tougher than the first material.

The surface conditioning article may be implemented such that the second material has a higher durometer than the first material.

The surface conditioning article may be implemented such that the first material is a polyester and the second material is a polyamide.

The surface conditioning article may be implemented such that the first material has a first stiffness, the second material has a second stiffness, and the first stiffness differs from the second stiffness.

The surface conditioning article may be implemented such that the first material has a first glass transition temperature, the second material has a second glass transition temperature, and the first glass transition temperature differs from the second glass transition temperature.

The surface conditioning article may be implemented such that the first material has a first melting point, the second material has a second melting point and the first melting point differs from the second melting point.

The surface conditioning article may be implemented such that a stiffness of each of the elongate elements varies along a length of the elongate element.

The surface conditioning article may be implemented such that a hub stiffness, at a hub connecting point, is higher than a tip stiffness, at a point opposite the hub connecting point.

The surface conditioning article may be implemented such that the plurality of elongate elements is a first plurality of elongate elements, and the surface conditioning article further includes: a second plurality of elongate elements, each including a third material, different from the second material.

The surface conditioning article may be implemented such that the third material includes a second plurality of abrasive particles different from the first plurality of abrasive particles.

The surface conditioning article may be implemented such that the third material includes a third polymer different from a second polymer of the second material.

The surface conditioning article may be implemented such that each of the elongate elements has a leading edge, including a leading material with a first modulus, and a trailing edge, including a trailing material with a second modulus, and the second modulus is stiffer than the first modulus.

The surface conditioning article may be implemented such that each of the elongate elements has a leading edge, including a leading material, and a trailing edge, including a trailing material, and the second material is softer than the first material.

The surface conditioning article may be implemented such that the first material and the second material include a component selected from the group consisting of: a thermoplastic polymer, a thermosetting polymer, and a thermoplastic elastomer.

The surface conditioning article may be implemented such that the hub includes a hub axis.

The surface conditioning article may be implemented such that the plurality of primary elongate elements extend radially from the hub.

The surface conditioning article may be implemented such that the plurality of primary elongate elements extend axially from the hub generally parallel to the hub axis.

The surface conditioning article may be implemented such that a portion of the plurality of primary elongate elements extend axially from the hub generally parallel to the hub axis, and a portion of the plurality of primary elongate elements extend radially from the hub.

The surface conditioning article may be implemented such that a portion of the plurality of primary elongate elements extend both radially and axially from the hub.

The surface conditioning article may be implemented such that the article includes a brush, the plurality of elongate elements are bristles of the brush.

The surface conditioning article may be implemented such that the article includes a rotary brush, the plurality of elongate elements are bristles of the rotary brush.

The surface conditioning article may be implemented such that one or more of the elongate elements includes an end-of-life indicator.

The surface conditioning article may be implemented such that the end-of-life indicator includes an indication of a portion of service life remaining.

The surface conditioning article may be implemented such that the elongate elements include a breakdown feature.

The surface conditioning article may be implemented such that the breakdown feature includes a notch, a textured surface, a slit, an etching, a smaller diameter than an average diameter of the elongate elements.

A method of forming an abrasive article is presented that includes causing a first material to fill a first mold, the first material forms a hub in the first mold. The method also includes causing a second material to fill a second mold. The second material forms a plurality of elongate abrasive elements extending from the hub. The method also includes allowing the mixture to set such that the elongate abrasive elements are coupled to the hub such that the second material is coupled to the first material. The first material is free of abrasive particles and the second material includes abrasive particles.

The method may be implemented such that the first mold is the second mold and the second material is injected first and the first material is injected.

The method may be implemented such that the second material is still in a flowable state when the first material is injected.

The method may be implemented such that causing the first material to fill the first mold includes heating the first material and flowing the first material into the first mold.

The method may be implemented such that the first mold includes a cavity having a negative shape of the hub and a plurality of extending features, such that the first material forms a unitary body including the hub and a plurality of extending features, and the second material, in the second mold, coats at least part of each of the plurality of extending features.

The method may be implemented such that the elongate abrasive elements each have an element length extending from a hub connection point to a tip opposite the hub connection point, and the plurality of extending features each have a feature length, and the feature length is less than the element length.

The method may be implemented such that the feature length is less than 50% of the element length.

The method may be implemented such that the feature length is greater than or equal to 50% of the element length.

The method may be implemented such that the second material covers a coat length of each of the elongate abrasive elements, the coat length being measured from the tip toward the hub connection point, and the coat length is less than the element length.

The method may be implemented such that the coat length is less than 80% of the element length.

The method may be implemented such that the coat length is less than 50% of the element length.

The method may be implemented such that the first material has a first stiffness, the second material has a second stiffness, and the first and second stiffnesses are different.

The method may be implemented such that the first material includes a filler material.

The method may be implemented such that the filler material includes a nonwoven material, chopped fiber or a scrim.

The method may be implemented such that the second material includes a first component and a second component, the first component forms the leading edge and the second component forms the trailing edge.

The method may be implemented such that the second component has a higher modulus than the first component.

The method may be implemented such that the second component is softer than the first component.

The method may be implemented such that the first component is more wear resistant than the second component.

The method may be implemented such that a stiffness of the elongate abrasive elements varies from a tip to a hub connection point.

The method may be implemented such that the plurality of elongate abrasive elements are a first plurality of elongate abrasive elements, and further including: causing a third material to fill a third mold, the third material forms a second plurality of elongate abrasive elements extending from the hub.

The method may be implemented such that the third mold is the second mold and the steps of causing the second material and causing the first material occur substantially simultaneously.

The method may be implemented such that the second material has a different property than the third material.

The method may be implemented such that the first material and the second material include a component selected from the group consisting of: a thermoplastic polymer, a thermosetting polymer, and a thermoplastic elastomer.

The method of may be implemented such that the first or second material includes an end-of-life indicator.

The method may be implemented such that the end-of-life indicator includes an indication of a portion of service life remaining.

The method may be implemented such that the second mold includes a breakdown feature.

The method may be implemented such that the breakdown feature imparts a surface texture to the elongate elements.

The method may be implemented such that the surface texture is a notch, a indentation, a slit, a restricted diameter.

1. A surface conditioning article comprising:
a hub portion, comprising a first polymer material, wherein the first material is free of abrasive particles; and
a plurality of elongate abrasive elements, each extending along an element axis, and each of the primary elongate abrasive elements comprising a second material, wherein
the second material comprises a plurality of abrasive particles.

2-4. (canceled)

5. The surface conditioning article of claim 1, wherein the first polymer material or the second material comprise a filler material.

6. The surface conditioning article of claim 1, wherein the plurality of elongate elements further comprises a third material.

7. The surface conditioning article of claim 1, wherein each of the plurality of elongate elements comprise the first polymer material and wherein the second material couples to the first material.

8. The surface conditioning article of claim 7, wherein each of the elongate elements has a length, and wherein the first polymer material comprises a first material length that is less than the length.

9. (canceled)

10. The surface conditioning article of claim 1, wherein the second material has a higher durometer than the first polymer material.

11. The surface conditioning article of claim 1, wherein the first polymer material is a polyester and the second material is a polyamide.

12. (canceled)

13. The surface conditioning article of claim 1, wherein the first polymer material has a first glass transition temperature, the second material has a second glass transition temperature, and wherein the first glass transition temperature differs from the second glass transition temperature.

14. The surface conditioning article of claim1, wherein a stiffness of each of the elongate elements varies along a length of the elongate element such that a hub stiffness, at a hub connecting point, is higher than a tip stiffness, at a point opposite the hub connecting point.

15. (canceled)

16. The surface conditioning article of claim 1, wherein the plurality of elongate elements is a first plurality of elongate elements, and wherein the surface conditioning article further comprises:
a second plurality of elongate elements, each comprising a third material, different from the second material; and wherein the third material comprises a second plurality of abrasive particles different from the first plurality of abrasive particles.
wherein the third material comprises a second plurality of abrasive particles different from the first plurality of abrasive particles.

17. The surface conditioning article of claim 1, wherein each of the elongate elements has a leading edge, comprising a leading material with a first modulus, and a trailing edge, comprising a trailing material with a second modulus, and wherein the second modulus is stiffer than the first modulus.

18. (canceled)

19. (canceled)

20. The surface conditioning article of claim 1, and further wherein one or more of the elongate elements comprises an end-of-life indicator.

21. (canceled)

22. The surface conditioning article of claim 1, wherein the elongate elements comprise a breakdown feature.

23. (canceled)

24. A method of forming an abrasive article, the method comprising
causing a first material to fill a first mold, wherein the first material forms a hub in the first mold;
causing a second material to fill a second mold, wherein the second material forms a plurality of elongate abrasive elements extending from the hub;
allowing the mixture to set such that the elongate abrasive elements are coupled to the hub such that the second material is coupled to the first material; and
wherein the first material is free of abrasive particles and wherein the second material comprises abrasive particles.

25. (canceled)

26. The method of claim 24, wherein the first mold comprises a cavity having a negative shape of the hub and a plurality of extending features, such that the first material forms a unitary body comprising the hub and a plurality of extending features, and wherein the second material, in the second mold, coats at least part of each of the plurality of extending features.

27. The method of claim 26, wherein the second material covers a coat length of each of the elongate abrasive elements, the coat length being measured from the tip toward the hub connection point, and wherein the coat length is less than the element length.

28. The method of claim 27, wherein the coat length is less than 80% of the element length.

29. (canceled)

30. The method of claim 24, wherein the first material comprises a filler material and wherein the filler material comprises a nonwoven material, chopped fiber or a scrim.

31. The method of claim 24, wherein the second material comprises a first component and a second component, wherein the first component forms the leading edge and the second component forms the trailing edge.

32-37. (canceled)

38. The method of claim 24, wherein the second mold comprises a breakdown feature.

39. (canceled)

40. (canceled)
